(19) United States
(12) Patent Application Publication
(10) Pub. No.: US 2021/0380369 A1
(43) Pub. Date: Dec. 9, 2021

(54) SWITCH DEVICE FOR ELEVATOR

(71) Applicant: TAIWAN NAME PLATE CO., LTD., TAOYUAN CITY (TW)

(72) Inventors: WEN-CHENG YIN, NEW TAIPEI CITY (TW); HO-CHUAN HSU, New Taipei City (TW); FU-JUNG CHENG, New Taipei City (TW)

(21) Appl. No.: 17/245,547

(22) Filed: Apr. 30, 2021

(30) Foreign Application Priority Data
Jun. 3, 2020 (TW) 109206935

(51) Int. Cl. B66B 1/14; B66B 1/34

(52) U.S. Cl. CPC B66B 1/14; B66B 1/3461

(57) ABSTRACT

A switch device for an elevator is arranged to manipulate a physical button of the elevator. The physical button is triggered to generate an operating signal to control the operation of the elevator. The switch device for the elevator includes a motion sensor, an actuator and a controller. The motion sensor detects the movement of a user to generate a sense signal. The actuator is disposed at the position corresponding to the physical button. The actuator presses the physical button based on a control signal. The controller is electrically connected to the motion sensor and the actuator. The controller receives the sense signal and generates the control signal based on the sense signal. The controller transmits the control signal to the actuator. A switch device of an elevator is able to manipulate the elevator under the condition that the user does not touch the physical button.

### CROSS-REFERENCE TO RELATED APPLICATION

This application claims the benefit from the Taiwan Patent Application No. 109206935, filed on Jun. 3, 2020, in the Taiwan Intellectual Property Office, the disclosures of which are hereby incorporated by reference in their entirety for all purposes.

### BACKGROUND OF THE INVENTION

### 1. Field of the Invention

The present invention relates to the technical field of the switch device, and particularly to be the switch device for the elevator.

### 2. Description of the Related Art

Contagion includes direct contagion and indirect contagion. Wherein, the indirect contagion is that after the object is touched by the infected person, microorganisms which cause infectious diseases may remain on the object touched by the infected person and therefore may cause infection to another person who is in contact with such object. The general indirect contagion is prone to occur in public places, such as the elevators, in which virus may remain on the buttons thereof.

To prevent infection, some people may press the buttons of the elevator through clothing or by utilizing the other object such as the key or the pen tip. Or, some people would wash hands immediately after touching the button to restrain the infection route. But the foregoing way about preventing infection causes a lot of inconvenience, the infection route is not effectively restrained. As long as the infection route is not effectively restrained, the infection will still occur.

Accordingly, the inventor of the present invention provides a switch device of the elevator to overcome deficiencies in terms of current techniques so as to enhance the implementation and application in industries.

### SUMMARY OF THE INVENTION

In view of the aforementioned known issues, the purpose of the present invention is to provide the switch device of the elevator to solve the problems found in the conventional techniques.

In order to achieve the objective, the present invention provides the switch device to manipulate a physical button of the elevator such that the physical button is triggered to generate an operating signal to control the operation of the elevator. The switch device of the elevator includes a motion sensor, an actuator and a controller. The motion sensor detects the movement of a user to generate a sense signal. The actuator is disposed at the position corresponding to the physical button. The actuator presses the physical button based on a control signal. The controller is electrically connected to the motion sensor and the actuator. The controller receives the sense signal and generates the control signal based on the sense signal. The controller transmits the control signal to the actuator. The switch device allows the elevator to be manipulated under the condition that the user does not physically touch the physical button.

Preferably, the elevator includes a plurality of the physical buttons and the switch includes a plurality of the actuators with a number corresponding to the number of the physical buttons. Each physical button may be triggered to generate an operating signal to control the operation of the elevator. Each of the actuators is disposed at the position corresponding to one of the physical buttons, and each of the actuators presses the corresponding physical button based on the control signal.

Preferably, the motion sensor includes a plurality of motion sensor, and each of the motion sensors senses the movement of the hand of the user to generate the sense signal. The controller generates the control signal based on the plurality of the sense signals and transmits the control signal to the actuator.

Preferably, the actuator includes a motor element and a cam element is disposed on a rotary shaft of the motor element. When the actuator receives the control signal, shaft of the motor element rotates to drive the cam element pressing the corresponding physical button.

Preferably, the sensing range of the motion sensor is a distance between the user hand and the motion sensor of more than 0 cm.

Preferably, the distance is less than or equal to 15 cm.

The following paragraphs utilizes the specific embodiments taken in conjunction with the accompanying drawing to describe the technical feature of the present invention, to make the person skilled in the art easy to understand the objective, the technical feature, the advantage of the present invention.

### BRIEF DESCRIPTION OF THE DRAWINGS

To explicitly describe the technical solution of the embodiments of the present invention, the following context would simply introduce the accompanying drawings which are needed to use in the description of the embodiments of the present invention. Apparently, the following drawings merely show some embodiments of the present invention. Those skilled in the art would learn the other drawing from these drawings of the present invention with freely experiment.

FIG. 1 is the block diagram of the first embodiment of the switch device for the elevator of the present invention.

FIG. 2 is the structure diagram of the actuator of the switch device for the elevator of the present invention.

FIG. 3 is the schematic diagram of the first embodiment of the switch device for the elevator of the present invention.

FIG. 4 is the block diagram of the second embodiment of the switch device for the elevator of the present invention.

FIG. 5 is the schematic diagram of the second embodiment of the switch device for the elevator of the present invention.

### DESCRIPTION OF THE PREFERRED EMBODIMENTS

To understand the technical features, the context, the advantages and the unexpected result of the present invention, the present invention taken in conjunction with the accompanying drawing is amply described in form of the embodiments. The drawings used in the embodiments are only aimed at exemplifying and aiding the specification instead of the actual proportion and the accurate configuration of the practiced present invention. The actual claim scope of the present invention in practice is not construed as and limited to the proportion and the configuration of the accompanying drawings.

It will be understood that when an element is referred to as being “connected to,” “disposed on” or “mounted on” another element or layer, it can be directly connected to, or disposed on the other element, or one or more intervening elements may be present. Besides, the terms “first,” “second,” “third,” etc., are used for describing herein and is not construed to indicate or imply the relative importance or order or direction.

Hereinafter, the switch device for the elevator of the present invention will be described in detail with reference to the accompanying drawings for understanding. Like reference numerals denote like elements throughout the accompanying drawings and the written description.

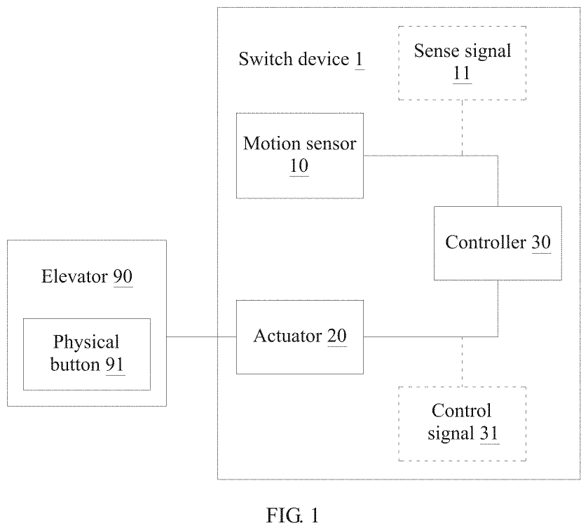

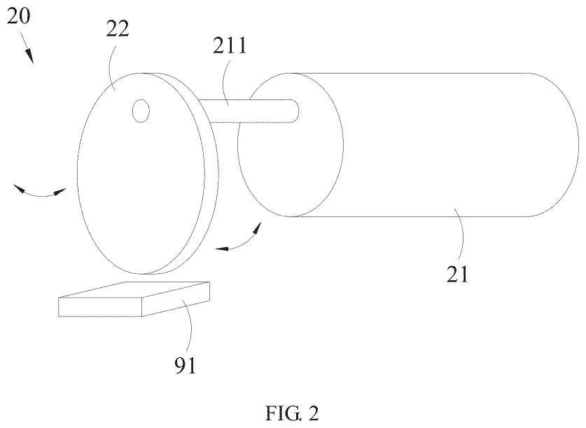

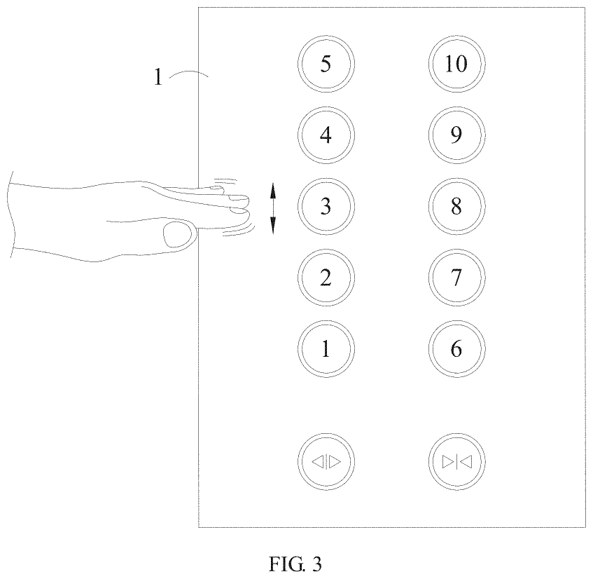

Please refer to FIG. 1 to FIG. 3. FIG. 1 is the block diagram of the first embodiment of the switch device for the elevator of the present invention. FIG. 2 is the structure diagram of the actuator of the switch device for the elevator of the present invention. FIG. 3 is the schematic diagram of the first embodiment of the switch device for the elevator of the present invention.

As shown by FIG. 1 to FIG. 3, the switch device 1 for the elevator is provided in the present application. The switch device 1 is used for manipulating the physical button 91 of the elevator 90, for example, pressing the physical button 91. The physical button 91 of the elevator 90 may be a floor button, a call button, an open button, a close button or a hold button. The physical button 91 may be triggered to generate an operating signal to control the operation of the elevator 90.

The switch device 1 for the elevator 90 includes the motion sensor 10, the actuator 20 and the controller 30. The motion sensor 10 detects the movement of a user to generate the sense signal 11. The motion sensor 10 may be the light sensor, the capacitance sensor or the photodiode, but is not limited thereto. For example, the user's hand movement or gesture may be waving, moving up, moving down, moving left, moving right, or moving in a circle. The actuator 20 is disposed at the position corresponding to the physical button 91. The actuator 20 may be disposed such that a movable part thereof may move in a direction to press the physical button 91. The actuator 20 may press the physical button 91 based on the control signal 31. The controller 30 is electrically connected to the motion sensor 10 and the actuator 20. The controller 30 receives the sense signal 11 and generates the control signal 31 based on the sense signal 11. The controller 30 transmits the control signal 31 to the actuator 20.

As shown by FIG. 2, specifically, the actuator 20 includes the motor element 21, and the cam element 22 is disposed on the rotary shaft 211 of the motor element 21. When the actuator 20 receives the control signal 31, the rotary shaft 211 of the motor element 21 rotates to drive the cam element 22 pressing the corresponding physical button 91.

As shown by FIG. 3, it is worthy to be mentioned that the switch device 1 for the elevator of the present invention is under a contactless control. Wherein, the sensing range of the motion sensor 10 is a distance between a user hand and the motion sensor 10 of more than 3 cm. Preferably, the sensing range of the motion sensor 10 is the distance between the user hand and the motion sensor 10 of more than 0 cm and less than or equal to 15 cm.

Or, the distance between the user hand and the motion sensor 10 may be set within a range of 3 cm to 15 cm. Here, the controller 30 determines whether the distance between the user's hand and the motion sensor 10 is overly proximate, specifically in a distance between 3 cm and 0 cm, for manipulation based on the nature of the sense signal 11. When the controller 30 determines the distance between the user hand and the motion sensor 10 is overly proximate for manipulation, the controller 30 may control the prompting unit (not illustrated by the drawing) to emit the prompting message. The prompting message may send an error message indicating a failure of manipulation to the user.

The switch device 1 for the elevator of the present invention may be configured to directly correspond to the plurality of physical button 91 of the elevator 90. Namely, the switch device 1 for the elevator of the present invention may have the motion sensors 10 and the actuators 20 corresponding to each physical button 91. Hereby, each actuator 20 presses the physical button 91 as a result of a motion sensed by the motion sensor 10. That is, the elevator includes a plurality of physical buttons 91, and the switch also includes a plurality of actuators 20, with a number corresponding to the number of the physical buttons 91. Each physical button 91 may be triggered to generate the operating signal to control the operation of the elevator 90. The actuators 20 are disposed at the position corresponding to the physical buttons 91. Each actuator 20 presses the corresponding physical button 91 based on the control signal 31.

For example, when the user wants to go up to the third floor, the user may wave his or her hand in front of the motion sensor 10 corresponding to the third floor, such that the motion sensor 10 corresponding to the third floor would generate the sense signal 11 and transmits it to the controller 30. Subsequently, the controller 30 may generate the control signal 31 based on the sense signal 11 and may transmit the control signal 31 to the actuator 20 corresponding to the third floor. Hence, the actuator 20 corresponding to the third floor would press the physical button 91 based on the control signal 31.

For example, when the user wants to keep the door open for a longer period of time, the user may wave his or her hand in front of the motion sensor 10 corresponding to the hold button and the motion sensor 10 corresponding to the hold button, such that the sense signal 11 may be generated and transmitted to the controller 30. Subsequently, the controller 30 would generate the control signal 31 based on the sense signal 11 and transmit the control signal 31 to the actuator 20 corresponding to the hold button. Hence, the motor element 21 of the actuator 20 would rotate based on the control signal 31 to make the cam element 22 press the physical button 91. When the user no longer wants the door open, the user may wave his or her hand in front of the motion sensor 10 corresponding to the “close” button and the actuator 20 would press the physical button 91 again.

In addition, more specifically, the shaft of the motor element 21 may be configured to rotate to a specific angle from the original point based on the control signal 31, thereby making the cam element 22 keep pressing the physical button 91. When the motor element 21 receives the control signal 31 again, the shaft of the motor element 21 may be rotated back to the original point and the cam element 22 stops pressing the physical button 91. Besides, when the controller 30 receives more than one sense signals 11 at the same time, the controller 30 may control the prompting unit (not illustrated by the drawing) to deliver the prompting message indicating an error of the manipulation to the user.

By the foregoing configuration, the user may manipulate the physical button 91 with the switch device 1 for the elevator of the present invention under the condition that the user does not physically touch the physical button 91. Hence, the present invention may solve the long-term public health problem such as bacterium/virus infection caused by touching the button.

Therefore, the switch device 1 for the elevator of the present invention is directly disposed on the plurality of the physical buttons 91 of the current elevator 90 to achieve the purpose for contactless manipulation on the elevator 90. By the switch device 1 for the elevator of the present invention, there is no need to change the original structure of the elevator 90. Hence, the switch device 1 for the elevator of the present invention has a wide range of application, and is not limited to the elevator with the specific brand.

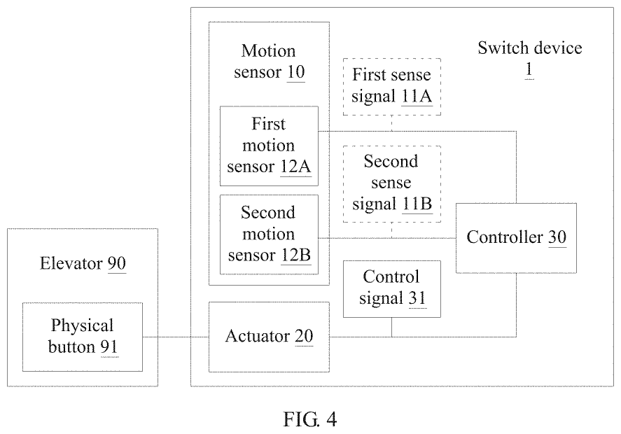

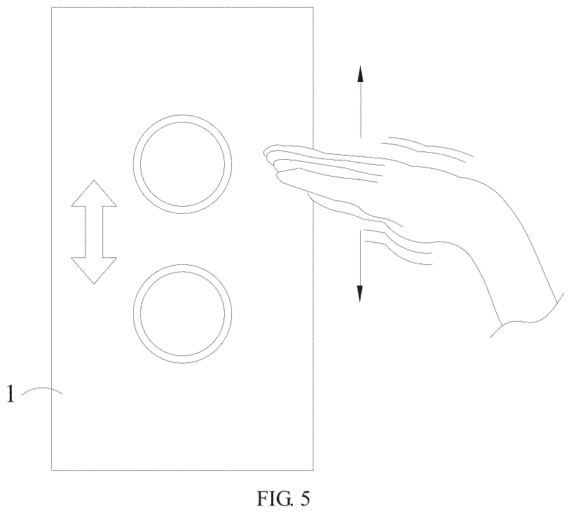

Please refer to FIG. 4 and FIG. 5. FIG. 4 is the block diagram of the second embodiment of the switch device for the elevator of the present invention. FIG. 5 is the schematic diagram of the second embodiment of the switch device for the elevator of the present invention.

As shown by FIG. 4 and FIG. 5, the motion sensor 10 includes the plurality of motion sensor such as the first motion sensor 12A and the second motion sensor 12B. The first motion sensor 12A and the second motion sensor 12B sense the movement of a user, for example, hand movement, to generate the first sense signal 11A and the second sense signal 11B. The controller 30 generates the control signal 31 based on the plurality of sense signals 11 and transmits it to the corresponding actuator 20.

In detail, when the switch device 1 for the elevator of the present invention is disposed on the physical buttons 91 of the elevator 90, if the user would like to go upstairs, the user may move his or her hand upward to firstly make the first motion sensor 12A sense the user's hand movement and to secondly make the second motion sensor 12B sense the user's hand movement, thereby generating the first sense signal 11A and the second sense signal 11B with a time difference. In such a case, the controller 30 would generate the control signal 31 requesting the elevator going upstairs based on the condition that the order of the first sense signal 11A and the second sense signal 11B and transmits the control signal 31 to the corresponding actuator 20. On the other hand, if the user would like to go downstairs, the user may move his or her hand downward to firstly make the second motion sensor 12B sense the user's hand movement and to secondly make the first motion sensor 12A sense the user's hand movement, thereby generating the first sense signal 11A and the second sense signal 11B. In such a case, the controller 30 would generate the control signal 31 requesting the elevator going downstairs based on the condition that the order of the first sense signal 11A and the second sense signal 11B and transmits the control signal 31 to the corresponding actuator 20.

By the foregoing configuration, the user may manipulate the physical button 91 with the switch device 1 for the elevator of the present invention under the condition that the user does not physically touch the physical button 91. Hence, the present invention may solve the long-term public health problem such as bacterium/virus infection caused by touching the button. Also, the user utilizes the waving hand movement to control the operation of the elevator 90 intuitively, thereby enhancing practicality and the experience in use.

It is worthy to be mentioned that in the actual use or in the proper condition, the distance between the user hand and the motion sensor 10 set to be equal to or more than 0 cm. Hereby, the user may directly touch the switch device 1 for the elevator of the present invention.

The present invention may be realized in different forms and should not be construed as being limited to the embodiments mentioned herein. It is to be understood that many other possible modifications and variations can be made by persons having ordinary skill in the art without departing from the spirit and scope of the invention as hereinafter claimed.

What is claimed is:

1. A switch device for manipulating a physical button of an elevator, the physical button being triggered to generate an operating signal to control operations of the elevator, the switch device comprising:
a motion sensor configured to detect a movement of a user to generate a sense signal;
a controller electrically connected to the motion sensor, the controller being configured to receive the sense signal and generate a control signal accordingly; and
an actuator disposed at a position corresponding to the physical button, the actuator being electrically connected to the controller and configured to receive the control signal and manipulate the physical button based on the control signal.

2. The switch device of claim 1, wherein the elevator includes a plurality of the physical buttons, the switch device includes a plurality of the actuators with a number corresponding to the physical buttons, the physical buttons are configured to be triggered to generate a plurality of the operating signals to control the operations of the elevator, the actuators are respectively disposed on the positions corresponding to the physical buttons, and the actuators are each configured to manipulate the physical buttons based on the control signal.

3. The switch device of claim 2, wherein the switch device includes a plurality of the motion sensors configured to detect the movement of the user to respectively generate a plurality of the sense signals, the controller generates the control signals based on the sense signals and transmits the control signals to the actuators.

4. The switch device of claim 1, wherein the actuator includes a motor element, and a cam element is disposed on a rotary shaft of the motor element, when the actuator receives the control signal, the shaft of the motor element rotates to drive the cam element to press the physical button.

5. The switch device of claim 1, wherein a sensing range of the motion sensor is defined by a distance between a user hand and the motion sensor, and the distance is more than 0 cm.

6. The switch device of claim 5, wherein the distance is less than or equal to 15 cm.
